(19) United States
(12) Patent Application Publication
(10) Pub. No.: US 2011/0210234 A1
(43) Pub. Date: Sep. 1, 2011

(54) Concrete Form Brace

(76) Inventor: Robert James Garcia, JR., Aurora, CO (US)

(21) Appl. No.: 12/713,430

(22) Filed: Feb. 26, 2010

(51) Int. Cl. E04G 17/06; B23P 11/00

(52) U.S. Cl. 249/213; 29/428

(57) ABSTRACT

A brace used for retaining concrete forms contains a pair of elongate members pivotally coupled for selective adjustment by actuation of a turnbuckle assembly. This adjustment is used to place the concrete forms in a disposition that is perpendicular to horizontal no matter what may be the pitch of the ground or other flooring material upon which the brace resides.

### BACKGROUND

Conventional concrete is a mixture of lime, sand, and gravel. With the addition of water, a chemical reaction commences to harden the mixture. Typically, in the context of building construction, forms are prepared in advance to receive the viscous mixture, which is eventually poured into the forms. The mixture resides in the forms until the mixture hardens for a period of hours or days. The forms may be constructed of plywood mounted in a frame. In other instances, the forms are provided with design features that, by way of example, facilitate the use of insulation as described by U.S. Pat. No. 7,617,640 issued to Bradley or even baffles that deflect bullets as described in U.S. Pat. No. 4,928,468. The forms may be provided with decorative patterns that impart to the concrete. The concrete is not limited to traditional lime-based admixtures, as polymer concretes may also be used.

A problem frequently arises when setting up the forms. Whereas the walls of a building should be plumb, i.e., oriented in a vertical plane, the ground is irregular and almost never flat. This means that workers who erect the forms to pour a new building wall must accommodate the irregularities of the ground. This requires the use of various tools including levels, plumb-bobs, and shovels as the walls are erected. As considerable distances may be spanned by these forms, this entails a great deal of work. Moreover, if mistakes are made in erecting the forms, this presents potentially serious structural issues with the building walls being out of plumb and off-dimension.

### SUMMARY

The presently disclosed instrumentalities overcome the problems outlined above and advance the art by providing a brace for holding a concrete form in a manner that facilitates angular adjustment bringing the form into plumb.

In one embodiment, the brace contains a first elongate member provided with holes that may be used to secure the first elongate member to ground. This may be done, for example, by placing spikes, nails, bolts etc. through the holes, or by forming spikes on the first elongate member. A second elongate member is provided with holes for securing the second elongate member to a concrete form. A pivot joins the first elongate member with the second elongate member in such a manner as to permit angular adjustments between the first elongate member and the second elongate member. A turnbuckle assembly has a selectively adjustable length, and presents a first end and a second end. A first pivotable connector at a first locus couples the first end of the turnbuckle assembly with the first elongate member. A second pivotable connector at a second locus couples the second end of the turnbuckle assembly with the second elongate member. The first locus and the second locus are such that selective adjustments of the length of the turnbuckle assembly provides angular adjustment between the first elongate member and the second elongate member.

In one aspect, this structure may be used to support a concrete form, such as a sheet of plywood or textured panel. The capacity for angular adjustment facilitates assembly of a plurality of these structures to provide a recess into which concrete may be poured.

### BRIEF DESCRIPTION OF THE DRAWINGS

FIG. 1 is a front elevation view of a concrete brace according to one embodiment;

FIG. 2 is a right side bottom perspective view of the concrete brace;

FIG. 3 is a top plan view of the concrete brace;

FIG. 4 is a right side elevation view of the concrete brace;

FIG. 5 is a right side elevation view of a concrete brace according to an alternative embodiment; and

FIG. 6 is shows a plurality of concrete braces assembled into a form that is made-ready to receive concrete.

### DETAILED DESCRIPTION

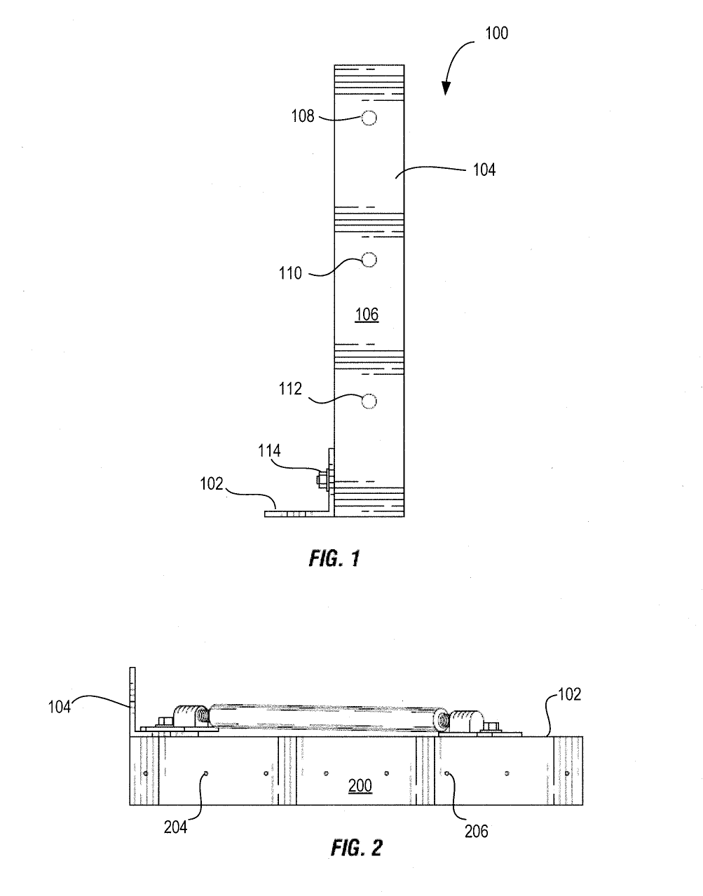

FIG. 1 is a front elevation view of brace assembly 100 formed of a first elongate member 102 and a second elongate member 104. In the embodiment of FIG. 1, the elongate members 102, 104 are angle irons. The second elongate member 104 has a face 106 through which are formed holes 108, 110, 112. The holes 108, 110, 112 are provided to receive bolts (not shown) that retain a concrete form (not shown) on face 106. A bolt assembly 114 pivotally couples the first and second elongate members 102, 104.

As seen from a bottom right perspective, FIG. 2, the first elongate member 102 presents a face 200 through which are formed a plurality of apertures including apertures 204, 206. The apertures 204, 206 are provided to receive nails (not shown) securing the first elongate member 102 to the ground.

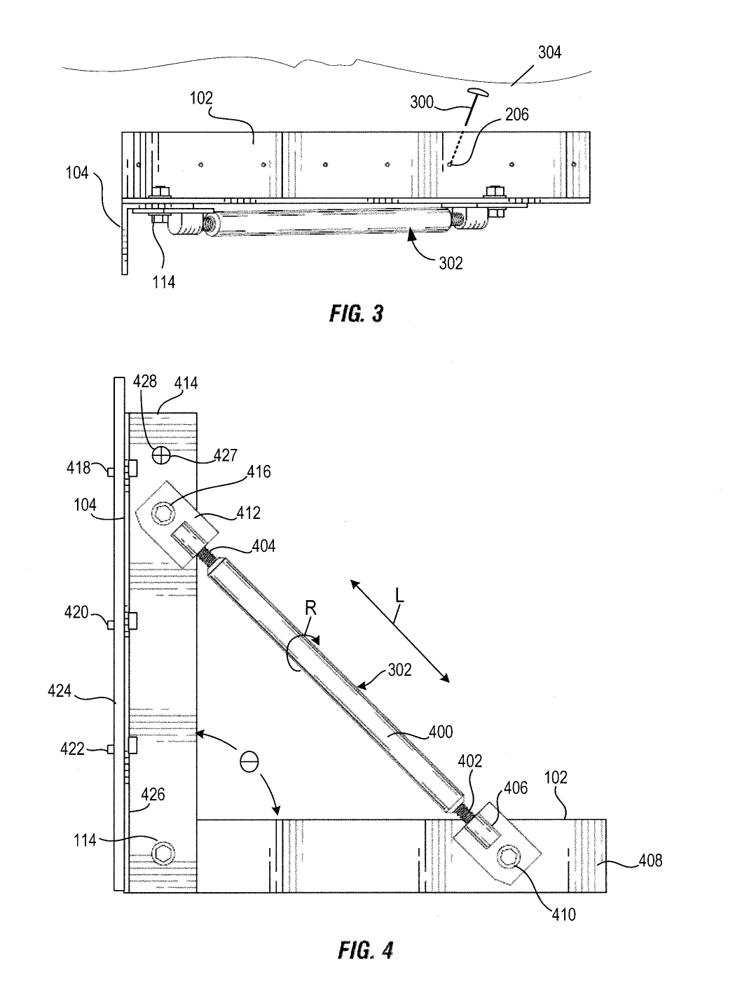

FIG. 3 is a top plan view showing nail 300 being placed in hole 206 to the first elongate member 102 to the ground 304, as described above. A turnbuckle assembly 302 extends between the first elongate member 102 and the second elongate member 104.

FIG. 4 is a right side elevation view that provides additional detail with respect to the turnbuckle assembly 302. A collar 400 is internally threaded to receive a first threaded stud 402 and a second threaded stud 404. The first threaded stud is integrally bonded with first end piece 406, which is pivotally bolted to wing 408 at first locus 410. Threaded stud 404 is integrally bonded with second end piece 412, which is pivotally bolted to wing 414 at second locus 416. Bolts 418, 420, 422 attach a concrete form 424 to wing 426 of the second elongate member 104. An optional hole 427 may be filled with a glass cross-hair target piece 428 (or any other target) for use in laser leveling.

It will be appreciated that rotational movement R reduces the length L of the turnbuckle assembly 302, and this results in a concomitant reduction in angle Θ. Reverse rotation lengthens the turnbuckle assembly with concomitant increase in angle Θ. The angle Θ may be an oblique angle or a right angle. This angular adjustment has two degrees of rotational freedom afforded by the pivot points (bolts) at bolt assembly 114, first locus 410, and second locus 416.

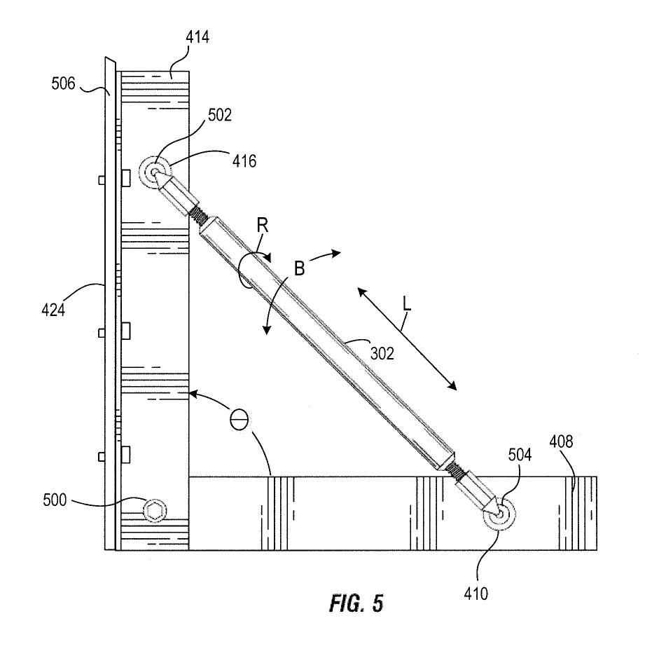

FIG. 5 shows an alternate embodiment affording three degrees of rotational freedom. In this embodiment, bolt 114 has been replaced with a ball joint 500. The bolts art loci 410, 416 have also been replaced with ball joints 502, 504. By this arrangement, pressure exerted on side 506 of concrete form 424 permits the assembly to tilt in a third dimension indicated by the angle β.

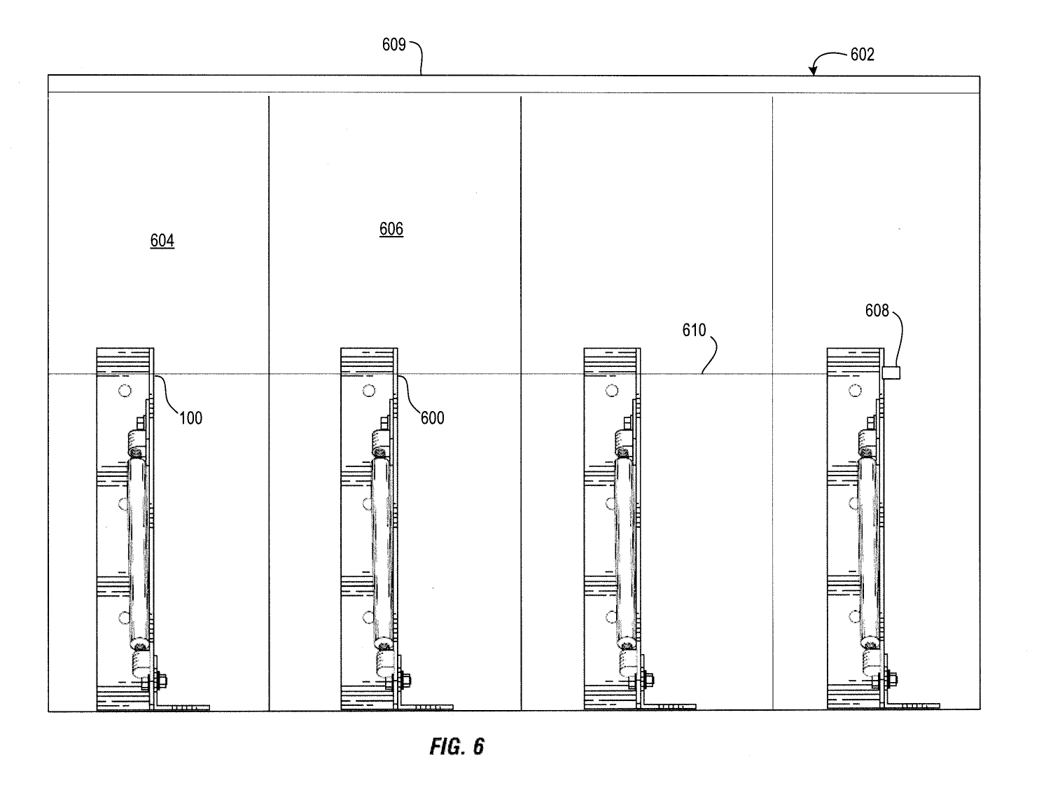

FIG. 6 shows how a plurality of braces, such as braces 100, 600, may be assembled to provide a form assembly 602 that is made-ready to receive concrete. The form assembly is made of individual panels 604, 606 that are suitably reinforced by framing 609. A laser leveling device 608 is optionally mounted to project beam 610 through a plurality of targets (see glass cross-hair target 428 of FIG. 4) to assure proper alignment of the braces 100, 600 and to facilitate turnbuckle adjustments as described above.

Those skilled in the art will appreciate that the foregoing discussion teaches by way of example and not by limitation. Insubstantial departures may be made from what has been specifically shown and described, without departing from the spirit of the invention. Accordingly, the inventor states his intention to rely, as may be needed, upon the Doctrine of Equivalents to protect the scope of the invention.

I claim:

1. A brace for holding a concrete form, comprising:
a first elongate member provided with means for securing the first elongate member to ground;
a second elongate member provided with means for securing the second elongate member to a concrete form;
a pivot joining the first elongate member with the second elongate member in such a manner as to permit angular adjustments between the first elongate member and the second elongate member;
a turnbuckle assembly having a selectively adjustable length, the turnbuckle assembly having a first end and a second end;
a first pivotable connector at a first locus coupling the first end of the turnbuckle assembly with the first elongate member; and
a second pivotable connector at a second locus coupling the second end of the turnbuckle assembly with the second elongate member, the first locus and the second locus being such that selective adjustments of the length of the turnbuckle assembly provides angular adjustment between the first elongate member and the second elongate member.

2. The brace of claim 1, where the means for securing the first elongate member includes a plurality of apertures formed there through.

3. The brace of claim 1, where the means for securing the second elongate member includes a plurality of holes formed there through.

4. The brace of claim 1, wherein the angular adjustment places the first elongate member and the second elongate member at an oblique angle to one another.

5. The brace of claim 1 further comprising a target for receiving laser light.

6. The brace of claim 5 further comprising a plurality of said braces made-ready to receive poured concrete and a laser device mounted to facilitate alignment of the plurality of braces.

7. A method of creating a form assembly, comprising:
(a) providing a brace for holding a concrete form that includes a first elongate member provided with means for securing the first elongate member to ground,
a second elongate member provided with means for securing the second elongate member to a concrete form,
a pivot joining the first elongate member with the second elongate member in such a manner as to permit angular adjustments between the first elongate member and the second elongate member,
a turnbuckle assembly having a selectively adjustable length, the turnbuckle assembly having a first end and a second end,
a first pivotable connector at a first locus coupling the first end of the turnbuckle assembly with the first elongate member, and
a second pivotable connector at a second locus coupling the second end of the turnbuckle assembly with the second elongate member,
the first locus and the second locus being such that selective adjustments of the length of the turnbuckle assembly provides angular adjustment between the first elongate member and the second elongate member;
(b) securing the first elongate member to the ground;
(c) attaching a concrete form to the second elongate member;
adjusting the orientation of the concrete form by actuation of the turnbuckle assembly; and
(d) repeating steps (a), (b) and (c) to provide a form assembly made-ready for the receipt of concrete.

8. The method of claim 7, further comprising a step (e) of using laser light to facilitate alignment of the assembly.
